(19) United States
(12) Patent Application Publication
(10) Pub. No.: US 2015/0322268 A1
(43) Pub. Date: Nov. 12, 2015

(54) ENHANCED BULK HANDLING PROPERTIES OF POWDERS VIA DRY GRANULATION IN A CONTROLLED ATMOSPHERE

(71) Applicant: E I DU PONT DE NEMOURS AND COMPANY, Wilmington, DE (US)

(72) Inventors: TIMOTHY ALLAN BELL, WILLMINGTON, DE (US); DAVID RICHARD CORBIN, WEST CHESTER, PA (US); SCOTT HUTCHISON, WILMINGTON, DE (US); EUGENE MICHAEL MCCARRON, III, CHADDS FORD, PA (US); THOMAS C. CALVARESE, WILMINGTON, DE (US)

(73) Assignee: E I DU PONT DE NEMOURS AND COMPANY, Wilmington, DE (US)

(21) Appl. No.: 14/396,392

(22) PCT Filed: Mar. 29, 2013
(86) PCT No.: PCT/US13/34519

§ 371 Date: Oct. 23, 2014

Related U.S. Application Data
(60) Provisional application No. 61/642,515, filed on May 4, 2012.

(51) Int. Cl. C09C 1/36; C01G 23/047; C01G 23/08

(52) U.S. Cl. CPC C09C 1/3653; C01G 23/08; C01G 23/047; C01P 2004/50; C01P 2004/62; C01P 2004/61

(57) ABSTRACT

Powders such as pigmentary titanium dioxide (TiO₂) often demonstrate poor bulk handling properties. It is very cohesive, often dusty, and many grades have loose bulk densities that are lower than desired by customers for their processes. The present invention relates to a process for manufacturing low-dusting, smoothly-discharging, easily dispersible, powders such as pigmentary titanium dioxide that resist compaction, aging, lumping, and/or caking. Particularly, the present invention relates to a process for treating powders such as pigmentary titanium dioxide with ammonia or a similarly basic substance prior to or during agglomeration to produce a powder with improved bulk handling properties. The present invention also relates to powders treated as such, including titanium dioxide.

### FIELD OF THE INVENTION

Powders such as pigmentary titanium dioxide (TiO₂) often demonstrate poor bulk handling properties. Pigmentary TiO₂ is very cohesive, often dusty, and many grades have loose bulk densities that are lower than desired by customers for their processes. The present invention relates to a process for manufacturing low-dusting, smoothly-discharging, easily dispersible powders such as pigmentary titanium dioxide that resist compaction, aging, lumping, and/or caking. Such powders are generally subjected to jet-milling, sand-milling, hammer-milling, or other mechanical operations. Generally, such powders are used in foodstuffs, cosmetics, detergents, paint and plastics, inks, and elastomers.

### BACKGROUND

Powders such as titanium dioxide pigments, iron oxides pigments, pearlescent pigments, talc, and other metal oxide pigments are used in cosmetics, detergents paint, plastics, construction and other industries. Particularly, pigments or powders are added to a desired application, usually through intensive mixing, for the purposes of imparting color and/or opacification. Performance properties relevant to such applications include pigment dipersibility and ease of handling, metering, and dusting.

Dispersibility measures how easily the powder uniformly and intimately mixes in a system. Poor powder dispersion can cause large agglomerates that may result in lumps, surface imperfections, color streaks, and non-uniform or incomplete coloration. Also, dispersing agglomerated powders requires energy and time.

Inorganic pigments, generally as finely divided powder, are produced for paints, plastics, and elastomer industries. The powders are subjected to jet-milling, sand-milling, hammer-milling, roller-milling, or other mechanical operations as a finishing step in their production. While such mechanical operations may contribute to dispersibility and gloss, milled pigments exhibit poor dry flow characteristics and produce dust. Thus, using such powders requires resource-intensive measures in place, for example, for workplace safety, ecological, or quality assurance reasons. Also, valuable material is lost as a result of the dust problem.

Handling considers difficulties associated with storing, transportation, and mixing of the powders and pigments during manufacturing and processing. Powder stability is necessary for good storage and transportation, which averts aging, or powder clumping into large agglomerates when subjected to heat, humidity, and pressure. Stability advantageously uses an individual particle's high cohesive forces. It also depends on the compaction pressure or forming method used in making the agglomerates. Clearly, good dispersibility and good stability are necessary but mutually exclusive goals.

Powder handling problems include caking, rat holing, bridging, aging in compressed storage, and clogging with pigment flow loss in feed bins. Additional problems include preference for powders in pellet or granular form.

Although powders vary widely in their use, powders such as pigmentary titanium dioxide can generally have similar particle size and chemistry. However, differences between various grades, in cohesiveness, dustiness, or bulk density are generally caused by processing conditions that affect the particle surface, especially surface coatings. Thus, while these coatings can be manipulated to affect the bulk handling properties, it is often at the unacceptable expense of end-user pigment effectiveness. Furthermore, because mechanisms are not entirely understood, this leads to a trial-and-error based development processes. Also, increasing bulk density becomes important, for example, in powders such as titanium dioxide used in plastics. In such situations, physical volume occupied by the titanium dioxide pigment can limit the production capability of the plastics. Thus, a pigment with greater loose bulk density would have value to such customers. In some instances, the coatings-grade pigments have bulk densities so low that shipping containers cannot be filled to their legal weight limits. A denser product would reduce shipping cost for those products. Substantial increases in bulk density could reduce the required physical size of equipment used to store and mechanically transport pigment, leading to lower investment requirements.

All customers handling TiO2 have at least some problems with dust, particularly those receiving the product in bag or bulk bag (SBC) form. Reduction in dustiness will improve housekeeping requirements, reduce industrial hygiene concerns, and may reduce capital investment requirements for dust control equipment.

For most customers, TiO2 is their most difficult-to-handle material. While certain grades are more difficult to handle than others, enhanced flowability would be of competitive benefit for all grades. If the flowability can be substantially improved, the capital cost of customer pigment handling facilities may be reduced, since some extraordinary provisions for flow promotion can be eliminated. The maintenance cost associated with these facilities may also be reduced. Better flowability also improves the volumetric efficiency of screw feeders and rotary valves, reducing their required size and cost. Finally, the accuracy of dosing devices and process control schemes is enhanced with powders of superior flowability.

Thus, there is a need within the industry for a process that addresses the dispersibility issue without compromising stability and flow or the end-use properties of powders such as titanium dioxide. A need also exists to increase the loose bulk density without significantly affecting other physical properties of powders such as pigmentary titanium dioxide.

### SUMMARY OF THE INVENTION

This invention relates to a process for preparing powder with enhanced bulk handling property, comprising:
(A) contacting a powder with at least one gas in a controlled environment, wherein said at least one gas is capable of acting as a Lewis base in the aggregate to said powder;
(B) optionally, tumbling said powder in said controlled environment simultaneously for at least a portion of the time during contacting of said at least one gas with said powder.

In another embodiment, the powder of the above invention comprises titanium dioxide said at least one gas comprises at least one amine, such as ammonia.

This invention also relates to a powder treated with at least one gas, wherein said at least one gas, in the aggregate, is a Lewis base, such as ammonia, and said powder is titanium dioxide.

### DETAILED DESCRIPTION OF INVENTION

All percentages expressed herein are by weight of the total weight of the composition unless expressed otherwise. All ratios expressed herein are on a weight:weight (w/w) basis unless expressed otherwise.

Ranges are used herein in shorthand, to avoid having to list and describe each value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a,” “an,” and “the” are generally inclusive of the plurals of the respective terms. For example, reference to “a method” or “a food” includes a plurality of such “methods,” or “foods.” Likewise the terms “include,” “including,” and “or” should all be construed to be inclusive, unless such a construction is clearly prohibited from the context. Similarly, the term “examples,” particularly when followed by a listing of terms, is merely exemplary and illustrative and should not be deemed exclusive or comprehensive.

The term “comprising” is intended to include embodiments encompassed by the terms “consisting essentially of” and “consisting of.” Similarly, the term “consisting essentially of” is intended to include embodiments encompassed by the term “consisting of.”

The methods and compositions and other advances disclosed herein are not limited to particular equipment or processes described herein because, as the skilled artisan will appreciate, they may vary. Further, the terminology used herein is for describing particular embodiments only, is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

By “powder” herein is meant particulate matter variously called as pigment, filler, inerts, fillers, extenders, reinforcing pigments, or any other contextual reference to particulate matter.

By “enhanced bulk-handling” of a powder is meant that at least one of the following physical properties of said powder is improved in a desired direction. The physical properties may be measured by standard methods, or not: (1) smooth dischargeability; (2) low dusting; (3) agglomeration; (4) compaction resistance; (5) friability; (6) dispersibility; (7) increased loose bulk density; (8) better flowability; (9) cohesiveness; (10) aging resistance; (11) caking; (12) metering; (13) bridging; (14) rat-holing; (15) stability; (16) clogging; and (17) lumping; and (18) improved paint characteristics.

By “stable end-use properties” of powder, for example, titanium dioxide, is meant that at least one of the following properties is maintained within the acceptable usage standard for said powder: (1) tint strength; (2) scatter intensity; (3) S-rate; (4) 60-deg gloss; (5) primary surface area; (6) end-use dispersion; (7) screen pack performance; and (8) durability during handling and storage. One or more of these properties may be physically related.

It is an objective of this invention to produce free flowing, low dust pigment compositions, which can be dust free. It is also an objective of this invention for the pigment to have smooth flow and handling characteristics, resulting in little to no caking or compaction during storage and is easily dispersed after being stored in a compressed state. These loosely agglomerated particles can be used for coloring paint, inks, plastics, elastomers, cosmetics or ceramics and other powder materials. These low-dust, smoothly flowing compositions are particularly suitable for use with metering and feeding devices.

The invention is particularly effective with inorganic oxide pigments such as alumina, magnesia, titanium dioxide and zirconia. The pigments that can undergo the described process to provide the improved pigments of the present invention include any of the white or colored, opacifying or non-opacifying particulate pigments (or mineral pigments) known and employed in the surface coatings (e.g., paint) and plastics industries. For purposes of this present detailed description, the term pigments is used broadly to describe materials which are particulate by nature and nonvolatile in use and typically are most usually referred to as inerts, fillers, extenders, reinforcing pigments and the like and are preferably inorganic pigments.

Representative examples of pigments that can be treated are defined to provide the improved pigments of this invention include white opacifying pigments such as titanium dioxide, basic carbonate white lead, basic sulfate white lead, basic silicate white lead, zinc sulfide, zinc oxide, composite pigments of zinc sulfide and barium sulfate, antimony oxide and the like, white extender pigments such as calcium carbonate, calcium sulfate, china and kaolin clays, mica, diatomaceous earth and colored pigments such as iron oxide, lead oxide, cadmium sulfide, cadmium selenide, lead chromate, zinc chromate, nickel titanate, chromium oxide, and the like. Of all the pigments useful in producing the improved pigments of the present invention, the most preferred pigment is titanium dioxide. Other powders such as fertilizers can also be treated by the process of the present invention.

Titanium dioxide pigment for use in the process of this invention can be either the anatase or rutile crystalline structure or a combination thereof. The pigment may be produced by known commercial processes which are familiar to those of skill in this art but which those processes do not form any part of the present invention. The specific pigment can be produced by either the well-known sulfate process or the well-known vapor phase oxidation of titanium tetrachloride process.

The invention can be practiced on materials less than about one micron in average diameter, and is preferably practiced on pigments and fillers, having average particle sizes of about 0.01 to about 10 microns. The spherical agglomerates produced are preferably at least about 0.01 millimeters in diameter, most preferably from about 0.1 millimeters to about 4 millimeters in diameter.

The titanium dioxide particles are particularly useful in the present invention that include anatase and rutile crystalline forms and may be treated or coated, e.g., with one or more oxides or hydroxides of metals including aluminum, antimony, beryllium, cerium, hafnium, lead, magnesium, niobium, silicon, tantalum, titanium, tin, zinc, or zirconium. The pigments of titania or other inorganic oxides can contain aluminum, introduced by any suitable method, including the co-oxidation of halides of titanium, (or other metal) and aluminum as in the “chloride process” or the addition of aluminum compounds prior to calcination in the “sulfate process”. Other products, but not all inclusive, that can be manufactured as specified in this invention, to improve the properties include fly ash, powdered foodstuffs, cement, cosmetics, polytetrafluoroethylene, powders, talc and clay.

In one embodiment, the present invention relates to exposing powders such as pigmentary titanium dioxide to at least one gas and optionally simultaneously tumbling said powders which causes the formation of generally spherical agglomerates. These agglomerates have an increased loose bulk density, less dust, and better flowability than the original pigment. However, the end use dispersion, tint strength, and screen pack performance are unaffected. The agglomerates are durable enough to survive mechanical handling and storage.

In one embodiment of the present invention, powder such as a pigmentary titanium dioxide is loaded in an enclosed chamber such as a rotary evaporator. Optionally, the pigment is tumbled within a range of rotational speed and a specified range of temperature, but generally at ambient temperature. A controlled atmosphere is created for the powder in the enclosed chamber by passing a selected gas through the headspace of the enclosed chamber, for example, the evaporator. After a specified duration of time, the powder is transformed into generally spherical agglomerates of particular size. The loose bulk density is improved, as a result. The present invention also reduces or completely eliminates dusting. The agglomerates have sufficient strength to withstand mechanical conveying and silo storage without significant loss of their beneficial properties. The invention is demonstrated for various titanium dioxide pigment grades, including products intended for paper, coatings and plastics. End use performance is unaffected by the process.

In another embodiment, the powder treated by the process of the present invention will have an improved loose bulk density, but the surface area, as measured by the BET method, will be different by about 20% from that of the untreated powder. Surface area of the treated powder can be different by 0, 1, 2, 3, 4, 5, 6, 7, 8, 9, 10, 11, 12, 13, 14, 15, 16, 17, 18, 19, and 20% of the original untreated powder.

In one embodiment, the enclosed chamber is rotary, such as a rotary evaporator. The powder is tumbled in the rotary evaporator at a rotational speed of from about 5 rpm to 100 rpm. The rotary speed can be one of the following speeds, or a series of speeds selected from the following speeds, measured in rpm:

5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

In other embodiments, the rotary speed is selected from a range defined by any two numbers of the above list.

0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

In other embodiments, the temperature is selected from a range defined by any two numbers of the above list.

The agglomeration operation is carried out under controlled atmosphere, wherein generally, the gas or the mixture of gases are capable of acting as Lewis bases in the aggregate. By a Lewis base is meant any species that is capable of donating a pair of electrons to a Lewis acid to form a Lewis adduct. In one embodiment, the Lewis base in ammonia. In another embodiment, the gas comprises ammonia, and air. Various alkyl amines, primary, secondary, or tertiary, can be used in gas form, such as, monoethanolamine, diethanolamine, methyldiethanolamine, and diglycolamine. If a higher amine is used, it is likely that the treatment will require elevated temperatures to render the amine in a gaseous form. This invention also envisions using alkyl amines that are amenable to being rendered in a gaseous form at elevated temperatures. This invention also includes inorganic derivatives of ammonia, such as chloramine (NClH₂). Combinations of gases that are a Lewis base in aggregate can also be used for creating the controlled atmosphere in the present invention.

Generally, the controlled environment treatment of the powder, for example in the rotary evaporator is the ambient temperature. However, the temperature can be one of the following temperatures, or a series of temperatures selected from the temperature range of from about 0° C. to 250° C. During an operation, the temperature of treatment can be at least one of the following temperatures, measured in ° C.:

0, 1, 2, 3, 4, 5, 6, 7, 8, 9, 10, 11, 12, 13, 14, 15, 16, 17, 18, 19, 20, 21, 22, 23, 24, 25, 26, 27, 28, 29 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, and 250.

The temperature can be any number within a range defined by any two numbers in the above list.

Generally, the controlled environment treatment of the powder is carried out for about 5 min to about 150 min. The treatment can be carried out for the time (in minutes) selected from the following list:

5, 6, 7, 8, 9, 10, 11, 12, 13, 14, 15, 16, 17, 18, 19, 20, 21, 22, 23, 24, 25, 26, 27, 28, 29 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 1, 3, 104, 105, 106, 107, 108, 109, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, and 150.

In other embodiments, the time of treatment is selected from a range defined by any two numbers of the above list.

The loose agglomerate average particle size can range from about 0.1 mm to about 5 mm in average diameter. Generally, the loose agglomerate particles are spherical. The average particle size can be one from the following sizes, in mm:

0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, and 5.0.

In other embodiments, the average particle size is selected from a range defined by any two numbers of the above list.

The loose bulk density of the powder treated by the process of the present invention is improved by about 10% to about 120%. The loose bulk density of the powder is improved by a number from the following list, in percentage improvement over the untreated powder loose bulk density:

10, 11, 12, 13, 14, 15, 16, 17, 18, 19, 20, 21, 22, 23, 24, 25, 26, 27, 28, 29 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 1, 3, 104, 105, 106, 107, 108, 109, 111, 112, 113, 114, 115, 116, 117, 118, 119, and 120.

In other embodiments, the loose bulk density improvement is selected from a range defined by any two numbers of the above list.

The Johansson Indicizer Rathole Index (RHI) that measures the flowability of the powder is decreased by 5% to about 120%. The flowability, as measured by RHI, of the powder is improved by a number from the following list, in percentage improvement over the untreated powder loose bulk density:

5, 6, 7, 8, 9, 10, 11, 12, 13, 14, 15, 16, 17, 18, 19, 20, 21, 22, 23, 24, 25, 26, 27, 28, 29 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 1, 3, 104, 105, 106, 107, 108, 109, 111, 112, 113, 114, 115, 116, 117, 118, 119, and 120.

In other embodiments, the RHI improvement is selected from a range defined by any two numbers of the above list.

### EXPERIMENTAL

### Example 1

### Titanium Dioxide Grades for Inclusion as Paper Pigments

Two samples of titanium dioxide powder, R794 and R796 plus were used in this experiment. Each sample was loaded into a rotary evaporator with a spherical diameter of 12 inches. The pigment was tumbled in the evaporator at 30 RPM at ambient temperature while being exposed to a selected gas flowing through the headspace of the evaporator. In the first instance, N2 was used. In the second instance, NH3 was used. The powder was transformed into generally spherical agglomerates of approximately 0.5 mm to 2.5 mm diameter. The following properties of the three powders were measured: (1) Gilson Loose Bulk Density (GLBD), (2) Rathole Index (RHI), (3) Scattering Efficiency, (4) Retention, and (5) Isoelectric Point. The agglomerates demonstrated sufficient strength to withstand mechanical conveying and silo storage without significant loss of their beneficial properties such as scattering efficiency, tint and end use performance.

Improvements are obtained with ammonia (NH₃) being utilized as the head-space gas treatment. For example, the loose bulk density of type R-104 titanium dioxide was improved from 50.05 to 77.53 lb/ft³ with air as the treatment gas, while using ammonia resulted in an even higher loose bulk density of 95.90 lb/ft³. Data are given for two samples, R794 and R796plus.

Loose bulk density (BD) was measured as the most loosely packed bulk density when a material was left to settle by gravity alone. The loose bulk density utilized in these examples was measured using a Gilson Company nominal 3 inch sieve pan having a volume of 150.6 cm³. The material was hand sieved through a 10 mesh sieve over the tared sieve pan until overfilled. The top was scraped level using a large spatula blade at a 45° angle from the horizontal, taking care not to tamp or compress the contents of the cup. The cup was then weighed and the loose bulk density was then calculated.

The measured parameter referred to as rathole index (RHI), describes the degree of difficulty that can be expected in handling a powder. Typically the bulk flow of rutile titanium dioxide has a RHI of about 10 to about 24.

Powder flowability, particularly in silo and hopper situations, can be described using a variety of shear cell testing devices. One such device is the Johansson Hang-up Indicizer from Johansson Innovations. The Indicizer device compresses a sample of powder to a pre-determined compaction stress and then measures the force necessary to press a punch through the compacted powder. From the measured force, and a concurrent measurement of the volume of the powder following compaction, the Indicizer calculates an estimate of the propensity of the powder to form a rathole-type flow obstruction. The predetermined compaction stress level corresponds to an estimate of the stress in a silo. In these examples, the prototypical silo is considered to be 10 feet in diameter, and the Indicizer sets the compaction stress accordingly. The calculated parameter is known as rathole index (RHI) and describes the degree of difficulty that can be expected in handling a powder. Larger values of the RHI correspond to greater amounts of difficulty expected in handling the powder.

To obtain the test results reported in the Examples, a sample of each powder was carefully spooned into the test cell after being sieved through a 16-mesh sieve. Filling continued until the chamber was approximately 75% full. The cell was carefully weighed and then positioned into the Indicizer testing device. The powder weight and its volume were considered by the automated tester in both the calculation of the silo stresses and also the calculated propensity of the material to form a rathole. After the user input the sample weight and nominal silo diameter, the automated tester completed the test and displayed its estimated value of RHI.

Table 1.1 summarizes the results of GLBD measurement. Table 1.2 summarizes the results of the RHI. Table 1.3 summarizes the scattering efficiency data, Table 1.4 summarizes and Table 1.5 summarizes pH data, Table 1.6, the IEP data. Table 6 is a generalized summary of the experiments with additional information on the gas-treated samples.

TABLE 1.1
Gilson Loose Bulk Density

| | SS | N₂ | | % change | % change |
|---|---|---|---|---|---|
| Grade/ | control; | treatment; | NH₃ treatment; | after N₂ | after NH₃ |
| Treatment | g/cc | g/cc | g/cc | treatment | treatment |
| R794 | 0.66 | 0.98 | 0.90 | 48.5 | 36.4 |
| R796 Plus | 0.75 | 1.39 | 1.40 | 85.5 | 86.6 |

TABLE 1.2
Rat Hole Index (RHI)

| | SS | N₂ | NH₃ | % change | % change |
|---|---|---|---|---|---|
| Grade/ | control; | treatment; | treatment; | after N₂ | after NH₃ |
| Treatment | ft | ft | ft | treatment | treatment |
| R794 | 14 | 9.88 | 6.72 | 29 (decrease) | 52 (decrease) |
| R796 Plus | 14 | 6.43 | 7.10 | 54 (decrease) | 49 (decrease) |

TABLE 1.3
Scattering Efficiency Comparison

| | | | | % change | % change |
|---|---|---|---|---|---|
| Grade/ | SS | N₂ | | after N₂ | after NH₃ |
| Treatment | control | treatment; | NH₃ treatment; | treatment | treatment |
| R796 Plus | 0.1544 | 0.1597 | 0.1506 | +3.41% | −2.44% |

TABLE 1.4
Retention

| | | | NH₃ | % change | % change |
|---|---|---|---|---|---|
| Grade/ | SS | N₂ | treatment; | after N₂ | after NH₃ |
| Treatment | control; % | treatment; % | % | treatment | treatment |
| R796 Plus | 69.5 | 68.3 | 69.4 | −1.72% | −0.1% |

TABLE 1.5
pH Measurement

| | | | | % change | % change |
|---|---|---|---|---|---|
| Grade/ | SS | N₂ | NH₃ | after N₂ | after NH₃ |
| Treatment | control; | treatment; % | treatment; % | treatment | treatment |
| R796 Plus | 4.94 | 4.89 | 8.85 | −1.0% | 79% |

TABLE 1.6
IEP Measurement

| | | | | % change | % change |
|---|---|---|---|---|---|
| Grade/ | SS | N₂ | NH₃ | after N₂ | after NH₃ |
| Treatment | control; | treatment; % | treatment; % | treatment | treatment |
| R796 Plus | 7.41 | 7.40 | 6.75 | −0.1 | −8.9 |

TABLE 1.7
Additional Measurements

| | | | | HNG1005 (New | HNG1005 (New | HNG1005 (New |
|---|---|---|---|---|---|---|
| | | Tapped Bulk | Hausner Ratio | Indicizer) Thru | Indicizer) Thru | Indicizer) |
| | Screen on | Density; g/cc | Loose Bulk Density/ | 10-mesh mass in | 10 mesh I.R., | Corrected |
| Sample | 10-mesh | (% increase) | Tapped Bulk Density | cell (g) | 10′ × 12″; ft | RHI; ft |
| R794SS | About 8% | 0.86 | 1.29 | 40.85 | 12.84 | 13.72 |
| | soft lumps | | | | | |
| R794 N₂ | About 2% | 1.17 | 1.13 | 49.81 | 9.65 | 9.88 |
| treated | soft lumps; | (36%) | | | | |
| | little balls | | | | | |
| R794 NH₃ | About 8% | 1.04 | 1.15 | 45.50 | 7.03 | 6.72 |
| treated | soft lumps; | (20.9%) | | | | |
| | Soft, larger | | | | | |
| | balls | | | | | |
| R796plus | About 10% | 0.79 | 1.37 | 35.64 | 13.28 | 14.25 |
| SS | soft lumps | | | | | |
| R796plus | 9% slightly | 1.03 | 1.16 | 43.72 | 6.79 | 6.43 |
| N₂ | harder lumps | 30.3%) | | | | |
| treated | | | | | | |
| NH₃ | 15% slightly | 0.95 | 0.02 | 40.27 | 7.34 | 7.10 |
| treated | harder lumps | (20.2%) | | | | |

### Example 2

### Titanium Dioxide Grades for Inclusion in Plastics

Several samples of titanium dioxide powder were evaluated from the plastics grade: R101, R102, R103, R104, R105, R108, R350, and DLS210. A non-plastic grade R931 was also used. Each sample was loaded into a rotary evaporator with a spherical diameter of 12 inches. The pigment was tumbled in the evaporator at 30 RPM at ambient temperature while being exposed to a selected gas flowing through the headspace of the evaporator. Air was used at room temperature and at 80° C. Two other gases were also used: N₂ and NH₃. The following properties of the three powders were measured: (1) Gilson Loose Bulk Density (GLBD) and Gilson Tapped Bulk Density (Tables 2.11 and 2.12), (2) Rathole Index (RHI) (Table 2.2), (3) Yield (Table 2.3), (4) Hausner Ratio (Table 2.4), (5) pH (Table 2.5), and (6) Isoelectric Point (Table 2.6). Table 2.7 summarizes additional data for the nine samples. The agglomerates demonstrated sufficient strength to withstand mechanical conveying and silo storage without significant loss of their beneficial properties such as scattering efficiency, tint and end use performance.

TABLE 2.11
Gilson Loose Bulk Density

| | | | | | | | | % change | % change |
|---|---|---|---|---|---|---|---|---|---|
| | | | | | | % change | % change | after RT | after 80° C. |
| Grade/ | SS control; | N2 treat- | NH3 treat- | RT Air | 80° C. Air | after N2 | after NH3 | air treat- | air treat- |
| Treatment | g/cc | ment; g/cc | ment; g/cc | treatment | treatment | treatment | treatment | ment | ment |
| R-101 | 0.75 | 1.39 | 1.40 | 1.31 | 1.37 | 85.3 | 86.7 | 73.6 | 81.6 |
| R-102 | 0.77 | 1.31 | 1.25 | | | 70.1 | 62.3 | | |
| R-103 | 0.79 | 1.23 | 1.01 | 1.13 | 1.19 | 55.7 | 27.8 | 43.1 | 50.0 |
| R-104 | 0.80 | 1.45 | 1.54 | 1.42 | 1.13 | 81.2 | 92.5 | 79.7 | 43.0 |
| R-105 | 0.88 | 1.42 | 1.27 | | | 61.4 | 44.3 | | |
| R-106 | 0.71 | 1.36 | 1.21 | | | 91.5 | 70.4 | | |
| R-350 | 0.83 | 1.44 | 1.55 | | | 73.5 | 86.7 | | |
| DLS-210 | 0.48 | 0.83 | 0.75 | | | 72.9 | 72.9 | | |
| R-108 | 0.71 | 1.36 | 1.21 | | | 72.7 | 55.35 | | |

TABLE 2.12
Gilson Tapped Bulk Density

| | | | | % | |
|---|---|---|---|---|---|
| | | | | change | |
| | SS | N₂ | NH₃ | after | |
| Grade/ | control; | treatment; | treatment; | N₂ | % change after |
| Treatment | lb/ft³ | lb/ft³ | lb/ft³ | treatment | NH₃ treatment |
| R-101 | 64.03 | 99.59 | 100.77 | 55.5 | 57.4 |
| R-102 | 65.33 | 93.10 | 87.46 | 42.5 | 33.9 |
| R-103 | 62.28 | 89.51 | 66.68 | 43.7 | 7.1 |
| R-104 | 69.59 | 103.06 | 112.54 | 48.1 | 61.7 |
| R-105 | 73.17 | 107.78 | 94.46 | 47.3 | 29.1 |
| R-350 | 72.37 | 102.11 | 108.34 | 41.1 | 49.7 |
| DLS-210 | 39.38 | 60.02 | 53.87 | 52.4 | 36.8 |
| R-108 | 60.07 | 96.74 | 81.72 | 61.0 | 36.0 |

TABLE 2.2
Rat Hole Index (RHI)

| | | | | % change | % change |
|---|---|---|---|---|---|
| | | N₂ | NH₃ | after N₂ | after NH₃ |
| Grade/ | SS control; | treatment; | treatment; | treatment | treatment |
| Treatment | ft | ft | ft | (decrease) | (decrease) |
| R-101 | 14.97 | 11.98 | 11.29 | 20.0 | 24.6 |
| R-102 | 12.68 | 7.70 | 7.77 | 3.9 | 38.7 |
| R-103 | 16.35 | 7.00 | 0.25 | 57.2 | 99.1 |
| R-104 | 19.71 | 15.46 | 15.26 | 21.6 | 22.6 |
| R-105 | 11.12 | 8.43 | 3.13 | 24.2 | 7.8 |
| R-350 | 19.37 | 14.09 | 10.55 | 27.3 | 45.5 |
| DLS-210 | 8.27 | 4.13 | 0.25 | 50.1 | 97.0 |
| R-108 | 14.91 | 9.94 | 0.25 | 33.3 | 98.3 |

TABLE 2.3
pH Measurement

| | | N₂ | NH₃ | % change | % change |
|---|---|---|---|---|---|
| Grade/ | | treatment; | treatment; | after N₂ | after NH₃ |
| Treatment | SS control; | % | % | treatment | treatment |
| DLS-210 | 4.33 | 4.38 | 8.11 | 1.0% | 87% |

TABLE 2.4
IEP Measurement

| | | N₂ | NH₃ | % change | % change |
|---|---|---|---|---|---|
| Grade/ | | treatment; | treatment; | after N₂ | after NH₃ |
| Treatment | SS control; | % | % | treatment | treatment |
| DLS-210 | 7.54 | 7.48 | 7.14 | −0.7 | −5.3 |

TABLE 2.5
Surface Area Measurement

| | SS | N₂ | | % change | % change |
|---|---|---|---|---|---|
| Grade/ | control; | treatment; | NH₃ treatment; | after N₂ | after NH₃ |
| Treatment | m²/g | m²/g | m²/g | treatment | treatment |
| R104 | 8.65 | 8.58 | 8.66 | −0.8% | 0.1% |
| DLS-210 | 42.2 | 42.3 | 43.0 | 0.2% | 1.8% |

TABLE 2.6
Yield

| Grade/ | Air-Room | | N₂ | |
|---|---|---|---|---|
| Treatment | Temperature | Air-80° C. | treatment | NH₃ treatment |
| R-101 | 95.9 | 93.9 | 96.7 | 97.5 |
| R-102 | | | 78.8 | 98.2 |
| R.103 | 97.6 | 96.6 | 95.7 | 98.9 |
| R-104 | 73.2 | 20.7 | 79.6 | 91.1 |
| R-105 | 20.9 | 89.4 | 98.8 | 87.9 |
| R-350 | | | 97.8 | 93.0 |
| DLS-210 | 96.0 | 96.3 | 98.1 | 99.4 |
| R-108 | 04.0 | 91.6 | 92.8 | 95.1 |
| R-931 | 97.0 | 96.0 | 96.7 | 99.7 |

TABLE 2.7
Additional Measurements

| | | | | HNG1005 | |
|---|---|---|---|---|---|
| | | | | (New | |
| | | | HNG1005 | Indicizer) | |
| | | | (New | Thru 10 | HNG1005 |
| | | Hausner Ratio | Indicizer) | mesh | (New |
| | | Loose Bulk | Thru 10 | I.R., | Indicizer) |
| | Screen on | Density/Tapped | mesh mass | 10′ × 12″; | Corrected |
| Grade | 10-mesh | Bulk Density | in cell (g) | ft | RHI; ft |
| R-101 | About 8% | 1.36 | 50.04 | 13.88 | 14.97 |
| | soft lumps | | | | |
| R-101; N₂ | 1% slightly | 1.15 | 69.13 | 11.40 | 11.98 |
| treated | harder lumps | | | | |
| R-101; NH₃ | 1% slightly | 1.16 | 68.69 | 10.87 | 11.29 |
| treated | harder lumps | | | | |
| R-102 | About 7% | — | 52.88 | 11.98 | 12.68 |
| | soft lumps | | | | |
| R-102; N₂ | All through; | 1.14 | 65.97 | 7.84 | 7.70 |
| treated | little balls | | | | |
| R-102; NH₃ | All through; | 1.13 | 62.20 | 7.90 | 7.77 |
| treated | little balls | | | | |
| R-103 | About 12% | 1.26 | 47.13 | 15.03 | 16.35 |
| | soft lumps | | | | |
| R-103; N₂ | All through; | 1.17 | 60.48 | 7.26 | 7.00 |
| treated | slightly | | | | |
| | harder lumps | | | | |
| R-103; NH₃ | 12% slightly | 1.06 | 47.14 | 0.24 | 0.25 |
| treated | harder lumps | | | | |
| R-104 | About 8% | 1.42 | 63.54 | 17.54 | 19.38 |
| | soft lumps | | | | |
| R-104; N₂ | About 12% | 1.16 | 81.17 | 14.47 | 15.68 |
| treated | soft lumps | | | | |
| R-104; NH₃ | About 3% | 1.18 | 82.67 | 14.20 | 15.36 |
| treated | soft lumps | | | | |
| R-105 | About 1% soft | 1.34 | 60.26 | 10.68 | 11.11 |
| | lumps | | | | |
| R-105; N₂ | About 1% | 1.22 | 76.62 | 8.45 | 8.43 |
| treated | slightly | | | | |
| | harder lumps | | | | |
| R105; NH₃ | About 1% | 1.20 | 67.38 | 4.04 | 3.12 |
| treated | slightly | | | | |
| | harder lumps | | | | |
| R-350 | About 10% | — | 63.07 | 17.54 | 19.37 |
| | soft lumps | | | | |
| R-350; N₂ | About 2% | 1.14 | 80.21 | 13.15 | 14.09 |
| treated | soft lumps; | | | | |
| | little balls | | | | |
| R-350; NH₃ | About 11% | 1.13 | 78.33 | 10.21 | 10.55 |
| treated | soft lumps; | | | | |
| | little balls | | | | |
| DLS-210 | About 2% | 1.31 | 33.55 | 8.31 | 8.27 |
| | soft lumps | | | | |
| DLS-210; N₂ | 0 | 1.16 | 40.48 | 4.87 | 4.11 |
| treated | | | | | |
| DLS-210; | About 0.6% | 1.16 | 37.90 | 1.09 | 0.25 |
| NH₃ treated | soft lumps | | | | |
| R-108 | About 2% | — | 51.23 | 13.83 | 14.91 |
| | soft lumps | | | | |
| R-108; N₂ | All through; | 1.14 | 68.60 | 9.70 | 9.94 |
| treated | little balls | | | | |
| R-108; NH₃ | About 12% | 1.09 | 57.34 | 0.73 no | 0.25 |
| treated | soft lumps; | | | compaction | |
| | larger balls | | | in cell | |
| R-104 | About 18% | — | 63.51 | 18.10 | 20.04 |
| | soft lumps | | | | |
| R-104; N₂ | About 12% | 1.15 | 81.47 | 14.11 | 15.25 |
| TiO₂ control | soft lumps | | | | |
| run | | | | | |
| R-104; | About 6% | 1.15 | 82.96 | 14.04 | 15.16 |
| Ammonium | soft lumps | | | | |
| salt | | | | | |

### Example 3

### Titanium Dioxide Grades for Inclusion in Coatings

Several samples of titanium dioxide powder were evaluated from the coatings grade: R-706, R-900, R-960, R-931, R-902+, and TS-6200. Each sample was loaded into a rotary evaporator with a spherical diameter of 12 inches. The pigment was tumbled in the evaporator at 30 RPM at ambient temperature while being exposed to a selected gas flowing through the headspace of the evaporator. Air was used at room temperature and at 80° C. Two other gases were also used: N₂ and NH₃. The following properties of the three powders were measured: (1) Gilson Loose Bulk Density (GLBD) and Gilson Tapped Bulk Density (Table 3.11, 3.12), (2) Rathole Index (RHI) (Table 3.2), (3) Yield (Table 3.3), (4) Hausner Ratio (Table 3.4), (5) pH (Table 3.5), and (6) Isoelectric Point (Table 3.6). Table 2.7 summarizes additional data for the six samples. The agglomerates demonstrated sufficient strength to withstand mechanical conveying and silo storage without significant loss of their beneficial properties such as scattering efficiency, tint and end use performance.

TABLE 3.11
Gilson Loose Bulk Density

| | | | | | | | | % change | % change |
|---|---|---|---|---|---|---|---|---|---|
| | | | | | | % change | % change | after RT | after 80° C. |
| Grade/ | SS control; | N₂ treat- | NH₃ treat- | RT Air | 80° C. Air | after N₂ | after NH₃ | air treat- | air treat- |
| Treatment | g/cc | ment; g/cc | ment; g/cc | treatment | treatment | treatment | treatment | ment | ment |
| R-706 | 0.79 | 1.20 | 1.13 | 1.13 | 1.18 | 51.01 | 42.56 | 43.0 | 49.4 |
| R-900 | 0.72 | 1.25 | 1.21 | | | 73.71 | 67.71 | | |
| R-960 | 0.63 | 1.06 | 1.06 | | | 67.83 | 66.84 | | |
| R-931 | 0.44 | 0.78 | 0.81 | 0.74 | 0.698 | 72.93 | 85.26 | 68.2 | 58.6 |
| R-902+ | 0.74 | 1.13 | 1.14 | | | 53.23 | 54.29 | | |
| TS-6200 | 0.78 | 1.22 | 1.05 | | | 57.83 | 35.52 | | |
| R-931 | 0.44 | | | 0.75 | 0.77 (at | | | 70.4 | 75.0 |
| | | | | | 50° C.) | | | | |

TABLE 3.12
Gilson Tapped Bulk Density

| | | N₂ | NH₃ | % change | % change |
|---|---|---|---|---|---|
| Grade/ | SS control; | treatment; | treatment; | after N₂ | after NH₃ |
| Treatment | lb/ft³ | lb/ft³ | lb/ft³ | treatment | treatment |
| R-706 | 64.27 | 88.16 | 78.44 | 37.2 | 22.0 |
| R-900 | 66.81 | 92.06 | 86.79 | 37.8 | 29.9 |
| R-960 | 58.65 | 74.78 | 74.07 | 27.5 | 26.3 |
| R-931 | 38.53 | 56.47 | 57.61 | 46.6 | 49.5 |
| R-902+ | 61.96 | 83.75 | 80.59 | 35.2 | 30.1 |
| TS-6200 | 66.68 | 87.59 | 75.82 | 31.3 | 13.7 |

TABLE 3.2
Rat Hole Index (RHI)

| | | | | % change | % change |
|---|---|---|---|---|---|
| | | | | after | after |
| | SS | N₂ | NH₃ | N₂ | NH₃ |
| Grade/ | control; | treatment; | treatment; | treatment | treatment |
| Treatment | ft | ft | ft | (decrease) | (decrease) |
| R-706 | 13.2 | 7.7 | 0.25 | 41.6 | Undefined 98.1 |
| R-900 | 14.01 | 8.26 | 5.7 | 41.0 | 59.3 |
| R-960 | 14.12 | 9.88 | 0.25 | 30.0 | Undefined 98.2 |
| R-931 | 14.25 | 9.72 | 1.1 | 31.8 | 92.3 |
| R-902+ | 12.83 | 12.04 | 0.25 | 6.1 | Undefined 98.1 |
| TS-6200 | 11.8 | 7.9 | 0.87 | 33.0 | 92.6 |

TABLE 3.3
pH Measurement

| | | | | % change | % change |
|---|---|---|---|---|---|
| Grade/ | SS | N₂ | NH₃ | after N₂ | after NH₃ |
| Treatment | control; | treatment; % | treatment; % | treatment | treatment |
| R-931 | 8.1 | 7.9 | 9.4 | −2.5% | 16.0% |

TABLE 3.4
IEP Measurement

| | | | | % change | % change |
|---|---|---|---|---|---|
| Grade/ | SS | N₂ | NH₃ | after N₂ | after NH₃ |
| Treatment | control; | treatment; % | treatment; % | treatment | treatment |
| R-931 | 5.47 | 5.51 | 5.94 | 0.7% | 8.6% |

TABLE 3.5
Surface Area Measurement

| | SS | | NH₃ | % change | % change |
|---|---|---|---|---|---|
| Grade/ | control; | N₂ treatment; | treatment; | after N₂ | after NH₃ |
| Treatment | m²/g | m²/g | m²/g | treatment | treatment |
| R-931 | 51.5 | 51.0 | 43.6 | −1.0 | −15% |

TABLE 3.6
Yield

| Grade/ | Air-Room | | | |
|---|---|---|---|---|
| Treat- | Temper- | | | |
| ment | ature | Air-80° C. | N₂ treatment | NH₃ treatment |
| R-706 | 94.6 | 93.5 | 98.7 | 98.5 |
| R-900 | | | 92.8 | 96.6 |
| R-960 | | | 97.6 | 93.9 |
| R-931 | 93.4 | 99.7 | 97.0 | 96.0 |
| | | (93.2 @ 50° C.) | (at 50° C. 99.7) | (at 50° C. 99.0) |
| R-902+ | 90.6 | 99.1 | 84.1 | 96.1 |
| TS- | | | 87.2 | 97.1 |
| 6200 | | | | |

TABLE 3.7
Additional Measurements

| | | | HNG1005 | HNG1005 | |
|---|---|---|---|---|---|
| | | | (New | (New | HNG1005 |
| | | Hausner Ratio | Indicizer) | Indicizer) | (New |
| | | Loose Bulk | Thru 10 | Thru 10- | Indicizer) |
| | Screen on | Density/Tapped | mesh mass | mesh I.R., | Corrected |
| Grade | 10-mesh | Bulk Density | in cell (g) | 10′ × 12″; ft | RHI; ft |
| R-706 | About 10% | 1.30 | 52.80 | 12.43 | 13.22 |
| | soft lumps | | | | |
| R-706; N₂ | 1% slightly | 1.18 | 60.14 | 7.87 | 7.74 |
| treated | harder lumps | | | | |
| R-706; NH₃ | 1% slightly | 1.12 | 52.93 | 1.22 | 0.25 |
| treated | harder lumps | | | | |
| R-900 | About 15% | 1.49 | 52.65 | 13.08 | 14.01 |
| | soft lumps | | | | |
| R900; N₂ | 1% slightly | 1.18 | 63.86 | 8.30 | 8.26 |
| treated | harder lumps | | | | |
| R-900; NH₃ | 1% slightly | 1.15 | 59.89 | 6.21 | 5.73 |
| treated | harder lumps | | | | |
| R-960 | About 6% | 1.49 | 46.94 | 13.18 | 14.13 |
| | soft lumps | | | | |
| R-960; N₂ | 1% slightly | 1.13 | 53.94 | 9.65 | 9.88 |
| treated | harder lumps | | | | |
| R-960; NH₃ | 1% slightly | 1.13 | 53.94 | 1.42 | 0.25 |
| treated | harder lumps | | | | |
| R-931 | | 1.40 | 40.10 | 13.58 | 14.59 |
| R-931; N₂ | | 1.13 | 38.72 | 8.34 | 8.35 |
| treated; 50° C. | | | | | |
| R-931; NH₃ | | 1.03 | 36.91 | 0.24 | 0.25 |
| treated; 50° C. | | | | | |
| R-931 | About 5% | 1.40 | 34.98 | 13.23 | 14.18 |
| | soft lumps | | | | |
| R-931; N₂ | 2% slightly | 1.21 | 39.68 | 9.52 | 9.72 |
| treated; RT | harder lumps | | | | |
| R-931; NH₃ | 4% slightly | 1.13 | 39.82 | 2.35 | 1.08 |
| treated; RT | harder lumps | | | | |
| R-931; Air; | About 2% | 1.15 | 37.85 | 3.44 | 2.41 |
| RT | soft lumps | | | | |
| R-931; Air; | About 2% | 1.13 | 38.25 | 3.30 | 2.23 |
| 50° C. | soft lumps | | | | |
| more | | | | | |
| spherical | | | | | |
| when heated | | | | | |
| R-902+ | About 3% | 1.34 | 52.79 | 11.45 | 12.04 |
| | soft lumps | | | | |
| R-902+; N₂ | About 2% | 1.19 | 60.90 | 9.05 | 9.16 |
| treated | soft lumps | | | | |
| R-902+; NH₃ | About 2% | 1.13 | 56.61 | 1.05 | 0.25 |
| treated | soft lumps | | | | |
| TS-6200 | About 4% | 1.38 | 55.01 | 11.27 | 11.82 |
| | soft lumps | | | | |
| TS-6200; N₂ | 1% slightly | 1.15 | 62.63 | 8.04 | 7.94 |
| treated | harder lumps | | | | |
| TS-6200; NH₃ | 2% slightly | 1.16 | 54.91 | 2.17 | 0.87 |
| treated | harder lumps | | | | |

### Example 4

### Surface Area Measurements

Surface area data were generated using the BET method on TiO₂ particles before treatment and post-treatment with N₂ and NH₃. While the RHI was significantly lowered, the density was significantly increased (see data above), the surface area remained constant. This shows that an increase in density improves the packing of the material but does not correspondingly decrease the internal particle surface area. The approach of the present invention provides a two-prong benefit, as a result. Data for coatings grade (R-104) and plastics grade (R-931) are provided below:

TABLE 4.1
Surface Area Measurement

| R-104 Samples | Surface Area; m²/g |
|---|---|
| R-104 SS | 8.65 |
| R-104 SS; N₂ treated | 8.58 |
| R-104 SS; NH₃ treated | 8.66 |

TABLE 4.2
Surface Area Measurement

| R-931 Samples | Surface Area; m²/g |
|---|---|
| R-931 SS | 51.5 |
| R-931 SS; N₂ treated | 51.0 |
| R-931 SS; NH₃ treated | 43.6 |

What is claimed is:

1. A process for preparing powder with enhanced bulk handling property, comprising:
(A) contacting a powder with at least one gas in a controlled environment, wherein said at least one gas is capable of acting as a Lewis base in the aggregate to said powder;
(B) optionally, tumbling said powder in said controlled environment simultaneously for at least a portion of the time during contacting of said at least one gas with said powder.

2. The process recited in claim 1, wherein said powder is a pigment.

3. The process as recited in claim 2, wherein said pigment comprises titanium dioxide.

4. The process as recited in claim 3, wherein said at least one gas comprises at least one amine.

5. The process as recited in claim 4, wherein said at least one amine comprises ammonia.

6. The process as recited in claim 5, wherein said controlled environment is maintained at a temperature in the range of from about 0° C. to about 250° C.

7. The process as recited in claim 4, wherein said at least one amine is selected from the group consisting of primary alkyl amines, secondary alkyl amines, and tertiary alkyl amines,

8. A powder treated with at least one gas, wherein said at least one gas, in the aggregate, is a Lewis base.

9. The powder as recited in claim 8, wherein said powder's loose bulk density is improved by about 10% to about 120% over the original powder.

10. The powder as recited in claim 8, wherein said powder substantially comprises loose agglomerates in the size range of from about 0.1 mm to 5 mm.

11. The powder as recited in claim 8, wherein said at least one gas comprises at least one amine.

12. The powder as recited in claim 11, wherein said at least one gas comprises ammonia.

13. The powder as recited in claim 8 with a Rathole Index less than about 10 ft.

14. The powder as recited in claim 8 with a surface area decrease less than about 20% of the original surface area.

15. The powder as recited in claim 8, wherein said powder has at least one of tint strength; scatter intensity; S-rate; 60-deg gloss; primary surface area; end-use dispersion; screen pack performance; and durability during handling and storage in the range of from about −20% to about +20% of the original powder.
